(19) United States
(12) Patent Application Publication
(10) Pub. No.: US 2009/0128628 A1
(43) Pub. Date: May 21, 2009

(54) SURVEILLANCE SYSTEM AND METHOD

(75) Inventors: David Reinitz, Haifa (IL); Amit Adam, Haifa (IL); Ran Gozali, Alon Hagalil (IL); Ron Zohar, Yokneam Illit (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Rafael - Armament Development Authority Ltd, Haifa (IL)

(21) Appl. No.: 12/095,316

(22) PCT Filed: Nov. 30, 2006
(86) PCT No.: PCT/IL06/01387

§ 371 Date: Oct. 7, 2008

(30) Foreign Application Priority Data
Nov. 30, 2005 (IL) 172289

(51) Int. Cl. H04N 7/18; G06N 5/02

(52) U.S. Cl. 348/143; 706/47; 706/59

(57) ABSTRACT

A system for surveillance of a region of interest. The system includes a number of monitors, each monitor operative to acquire and to transmit periodically a description of a respective portion of the region of interest. The monitors are operative to transmit the descriptions in a first communication channel with insufficient bandwidth for all the monitors to transmit the descriptions simultaneously. The system also includes a control station for allocating respective portions of the channel to the monitors for the transmissions according to a number of rules. One or more of the rules includes feedback from the monitors that is separate from the descriptions.

### FIELD AND BACKGROUND OF THE INVENTION

The present invention relates to video surveillance and, more particularly, to a system that can be deployed ad hoc for surveillance of a region of interest.

Closed circuit television systems for local surveillance are well-known. Such systems deploy a group of video cameras at fixed locations in a region of interest such as a building complex. The cameras are connected by coaxial cables to a monitoring station where an operator views the video streams from the cameras on video screens or on respective portions of a single video screen. If the number of cameras is relatively small, each camera has a dedicated screen or a dedicated screen portion. Otherwise, there are fewer screens or screen portion than cameras, and either the cameras are rotated among the screens or among the screen portions automatically or the operator rotates the cameras among the screens or among the screen portions, with each screen or screen portion being assigned to different cameras at different times. Usually, the video streams also are recorded.

There are situations, especially in security operations, where it would be highly advantageous to set up a similar system temporarily, e.g. for the duration of a short, local, military or police operation. Examples of such security operations include:

Hostage rescue. A building in which hostages are held would be placed under video surveillance for the duration of the rescue mission. In addition, video cameras would be deployed as needed by security forces entering the building as the forces advance towards the hostages.

Ambush. Video cameras would be deployed to monitor possible arrival routes of a target to be intercepted.

Perimeter defense. Video cameras would be deployed at the perimeter of a position held by a military unit to warn against attack.

Emergency Roadblock. Video cameras would be deployed around the roadblock and around roads leading to the roadblock.

### SUMMARY OF THE INVENTION

According to the present invention there is provided a system for surveillance of a region of interest, including: (a) a plurality of monitors, each monitor operative to acquire and to transmit periodically a description of a respective portion of the region of interest, the monitors being operative to transmit the descriptions in a first communication channel having insufficient bandwidth for all the monitors to transmit the descriptions simultaneously; and (b) a control station for allocating respective portions of the channel to the monitors for the transmissions according to a plurality of rules; wherein at least one of the rules includes feedback from the monitors that is separate from the descriptions.

According to the present invention there is provided a method of surveillance of a region of interest, including the steps of: (a) deploying, in the region of interest, a plurality of monitors, each monitor operative to acquire and transmit periodically a description of a respective portion of the region of interest; (b) providing a communication channel having insufficient bandwidth for all the monitors to transmit the descriptions simultaneously; and (c) allocating respective portions of the communication channel to the monitors for the transmissions according to a plurality of rules, at least one of the rules including feedback from the monitors that is separate from the descriptions.

A basic system of the present invention, for surveillance of a region of interest, includes a plurality of monitors and a control station. Each monitor acquires and periodically transmits, preferably wirelessly, a “description” of the portion of the region of interest that that monitor monitors. A “description” of a portion of the region of interest is one or more signals that constitute an instantaneous description of an aspect of that portion of the region of interest. Examples of such “descriptions” include a video frame, an audio signal sample, and a set of measured values of environmental variables such as temperature, pressure and chemical species concentrations. The monitors transmit their descriptions in a first communication channel that does not have enough bandwidth for all the monitors to transmit their descriptions simultaneously. Therefore, the control station allocates respective portions of the first communication channel to the monitors, which means that the control station decides which monitors are allowed to transmit at any given time, and in which respective portions of the first communication channel. For example, the monitors may share a set of frequency sub-channels that are fewer in number than the number of monitors, in which case the control station decides which monitors are allowed to transmit, and in which respective frequency subchannels the monitors are allowed to transmit; or the monitors may rotate among a set of time slots that are fewer in number than the number of monitors, in which case the control station decides which monitors are allowed to transmit, and in which respective time slots the monitors are allowed to transmit. The portions of the first communication channel are allocated according to a plurality of rules. The rules do not provide merely for periodic cycling through all the monitors. At least one of the rules takes into account feedback from the monitors that is separate from the transmitted descriptions (although the feedback could be related to the transmitted descriptions, or could be based on the transmitted descriptions).

Preferably, the feedback from the monitors is transmitted, most preferably wirelessly, by the monitors to the control station in a second communication channel that is separate from the first communication channel. Most preferably, the second communication channel has sufficient bandwidth for all the monitors to transmit their feedback substantially simultaneously. This is because the feedback typically is very sparse, in terms of data volume, compared to the descriptions. In fact, the second communication channel typically is much narrower than the first communication channel and nevertheless is wide enough to accommodate substantially simultaneous transmissions of all the feedback.

Preferably, each monitor is operative to identify one of the descriptions that the monitor acquires as an unusual description. The feedback from the monitors includes notification by the monitors of the occurrences of the unusual descriptions. The processing of the descriptions in this preferred system of the present invention is distributed, in the sense that it is the monitors, and not the control unit, that decide which descriptions are unusual. The criteria that a monitor uses to identify unusual descriptions may be either absolute criteria or relative criteria, for example criteria relative to a plurality of descriptions previously acquired by the monitor. Examples of absolute criteria include the brightness of a video frame exceeding an absolute threshold and the value of a pressure measurement exceeding an absolute threshold, either of which is indicative of an explosion in the region of interest. Examples of relative criteria include the brightness of a video frame exceeding the brightness of N preceding video frames by a threshold and a value of a pressure measurement exceeding the values of N preceding pressure measurements by a threshold, either of which is indicative of an explosion in the region of interest. Most preferably, the descriptions include video frames and each monitor identifies, as an unusual description, a video frame that includes unusual motion relative to a plurality of video frames previously acquired by the monitor.

Preferably, the monitors transmit the descriptions by broadcasting the descriptions, and the system also includes one or more terminals, separate from the control station, for receiving and displaying the broadcast descriptions. For example, if the descriptions include video frames, each terminal includes a video screen for displaying the video frames; if the descriptions include audio samples, each terminal includes a microphone for “displaying” the audio samples; and if the descriptions include values of temperature measurements, each terminal includes a display such as an LCD display for displaying the temperature values. Most preferably, each terminal is operative to receive descriptions from only one monitor at a time, and the control station is operative to decide, for each terminal, which monitor's descriptions are received by the terminal.

Preferably, the control station includes a plurality of display devices for displaying the descriptions currently being transmitted by the monitors. Most preferably, there are as many display devices as the number of monitors that transmit simultaneously in the first communication channel, and the control station assigns each display device to a respective one of the simultaneously transmitting monitors.

Preferably, each monitor is operative to record the displays that the monitor acquires while the monitor is denied permission to transmit in the first communication channel.

Corresponding to the basic system of the present invention, the present invention includes a method of surveillance of a region of interest. The monitors are deployed in the region of interest. Because the communication channel that the monitors use to transmit the descriptions is not wide enough for all the monitors to transmit simultaneously, respective portions of the communication channel are allocated to the monitors according to a plurality of rules. At least one of the rules takes into account feedback from the monitors that is separate from the descriptions.

Optionally, the rules are modified while the monitors are transmitting the descriptions.

Preferably, the monitors transmit the descriptions by broadcasting the descriptions. To each monitor, that has been allocated a portion of the communication channel for transmitting the monitor's descriptions, is assigned a respective terminal, and the descriptions that are broadcast by the monitor are displayed using the monitor's respective terminal. Note that the assigning of a terminal to a monitor need not be for the entire duration of that monitor's sharing of the communication channel. A terminal may be reassigned from one monitor to another at any time. Also note that more than one terminal may be assigned to the same monitor. That a terminal is “respective” to a monitor means that while the terminal is assigned to the monitor the terminal displays only descriptions that are broadcast by that monitor.

### BRIEF DESCRIPTION OF THE DRAWINGS

The invention is herein described, by way of example only, with reference to the accompanying drawings, wherein:

FIG. 1 is a high-level block diagram of a video system of the present invention;

FIG. 2 is a high-level block diagram of one of the video cameras of FIG. 1;

FIG. 3 is a high-level block diagram of the control station of FIG. 1;

FIG. 4 is a high-level block diagram of one of the personal terminal of FIG. 1;

FIG. 5 illustrates an exemplary deployment of a system of the present invention.

### DESCRIPTION OF THE PREFERRED EMBODIMENTS

The present invention is of a surveillance system which can be deployed temporarily for surveillance of a region of interest. Specifically, the present invention can be used for local reconnaissance in military operations.

The principles and operation of a surveillance system according to the present invention may be better understood with reference to the drawings and the accompanying description.

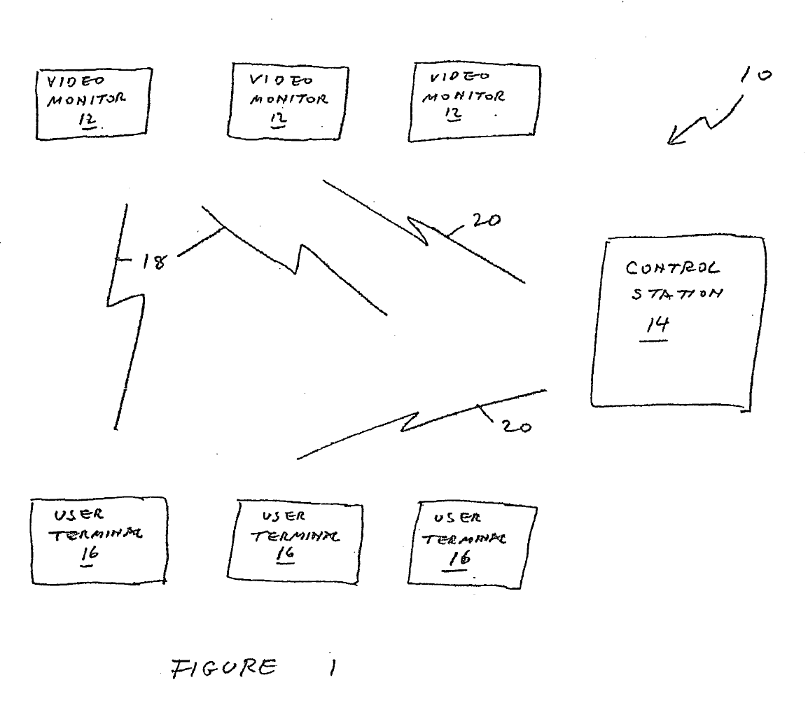

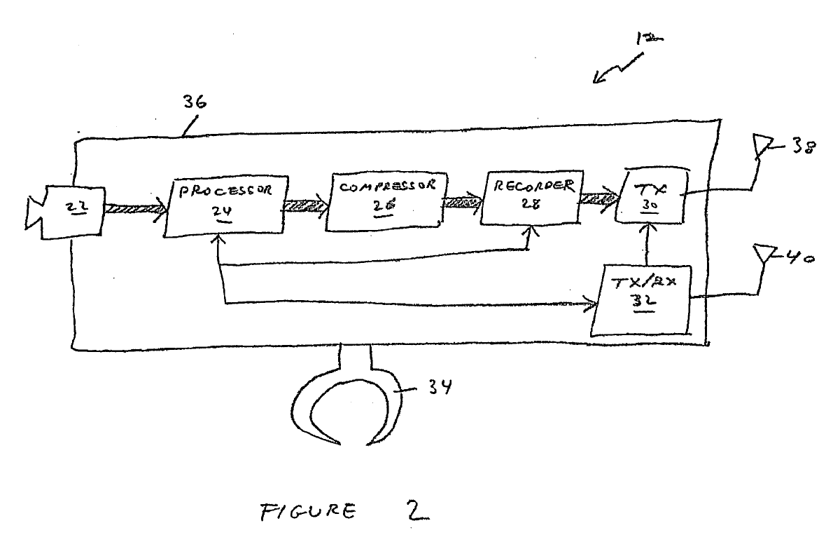

Referring now to the drawings, FIG. 1 is a high-level block diagram of a system 10 of the present invention, and FIGS. 2-4 are high-level block diagrams of the components of system 10 that are illustrated in FIG. 1.

FIG. 1 shows that system 10 includes a set of video monitors 12, a control station 14 and a set of portable user terminals 16.

Video monitors 12 are deployed in a region of interest. Each video monitor 12 acquires successive video frames of its own field of view in the region of interest and broadcasts those video frames in a common wireless video channel 18. The broadcasts are received by control station 14. As discussed below, there is not enough bandwidth in video channel 18 for all video monitors 12 to broadcast simultaneously, so control station 14 decides which video monitors 12 are allowed to broadcast and allocates respective subchannels of video channel 18 to those video monitors 12. Control station 14 uses wireless transmissions in an RF channel 20 to inform video monitors 12 which video monitors 12 are allowed to broadcast and in which respective subchannels of video channel 18. The decisions of control station 14 as to which video monitors 12 are allowed to broadcast are based in part on information transmitted back to control station 14 by video monitors 12 via RF channel 20.

The function of each user terminal 16 is to allow a user of user terminal 16 to view the broadcasts of one of video monitors 12. Each user terminal 16 is capable of receiving and displaying video frames that are broadcast in one of the subchannels of video channel 18. Control station 14 determines for each user terminal 16, via transmissions in RF channel 20, which subchannel that user terminal 16 receives and displays.

FIG. 2 is a high-level block diagram of a video monitor 12. In FIG. 2, the flow of video signals is indicated by thick arrows and the flow of control signals is indicated by thin arrows. The flow of video signals is from a video camera 22 to a processor 24 to a compressor 26 to a video recorder 28 to a video transmitter 30. Video camera 22 captures images of its field of view, which also is the field of view of video monitor 12, as video frames. The video frames are processed as described below by processor 24, compressed by compressor 26, optionally recorded by video recorder 28 and optionally broadcast in video channel 18 by video transmitter 30 using an antenna 38. Processor 24 preferably is a general-purpose programmable computer that, apart from processing the video frames, also exercises general control over video monitor 12. Compressor (e.g. a MPEG4 compressor) 26 preferably is implemented in firmware. Video recorder 28 preferably is based on a memory, such as a RAM, with sufficient capacity to hold the compressed video frames that video recorder 28 needs to store.

Video monitor 12 also includes a RF transceiver 32 that transmits and receives in RF channel 20 via an antenna 40. Transceiver 32 receives from control station 14 instructions of whether, and on which subchannel of video channel 18, to transmit video frames, and operates video transmitter 30 in accordance with those instructions. Transceiver 32 also receives from processor 24 information, derived from the video frames as described below, that control station 14 needs to decide whether to allow video monitor 12 to broadcast, and relays that information to control station 14.

These components are housed together in a common housing 36 that is equipped with a mechanism 34 for mounting and dismounting video monitor 12 as needed in the region of interest. Mechanism 34 also is operative to tilt housing 36 so as to change the field of view of video monitor 12 in response to commands received from control station 14 via RF channel 20. The field of view of video monitor 12 also is modified by commands received from control station 14 to video camera 22 to zoom in and out.

The recording by video recorder 28 and the broadcasting by video transmitter 30 are “optional” in the sense that video recorder 28 records video frames only if instructed to do so by processor 24 and video transmitter 30 broadcasts video frames only if instructed to do so by transceiver 32.

The processing by processor 24 is intended to identify video frames that indicate that something “interesting” is going on in the field of view of video monitor 12, and to notify control station 14 of that fact using transceiver 32. The kind of processing done by processor 24 depends on whether the “uninteresting” state of the scene that is observed by video monitor 12 is expected to be normally static or normally dynamic. For example, in some applications, such as perimeter defense, any significant motion in the scene is of interest, so that the “unteresting” state of the scene is a static state. The video frames of a normally static scene therefore are processed by the well-known and standard technique of video motion detection. In other applications, some motion is normally expected in the scene, so that the scene is normally dynamic. The video frames of a normally dynamic scene are processed to detect unusual motion of interest. Methods of detecting unusual motion are known in the art. See for example H. Zhong et al., “Detecting unusual activity in video”, IEEE Computer Society Conference on Computer Vision and Pattern Recognition (CVPR'04), Washington D.C., vol. 2 pp. 819-826, 27 Jun.-2 Jul. 2004. Typically, in the present invention, the detection of unusual motion is based on statistics of low-level features such as optical flow direction and the amount of motion in the scene. In addition, video frames of both normally static scenes and normally dynamic scenes are processed to detect unusual low-level video frame feature statistics that are not related to motion. For example, a sudden overall brightening of a scene could indicate an explosion.

The departure from the norm of a low-level statistic of a video frame may be a relative departure, such as a sudden brightening relative to a moving average of the preceding frames, or an absolute departure, such as brightening above a predetermined threshold. The detection of unusual low-level feature statistics require a learning period during which processor 24 learns the statistical distribution of “usual” feature statistics. The advantage of an absolute criterion is that no such learning period is required.

When processor 24 identifies an unusual event in the field of view of video monitor 12, processor 24 uses transceiver 32 to notify control station 14 of the occurrence and nature of the unusual event.

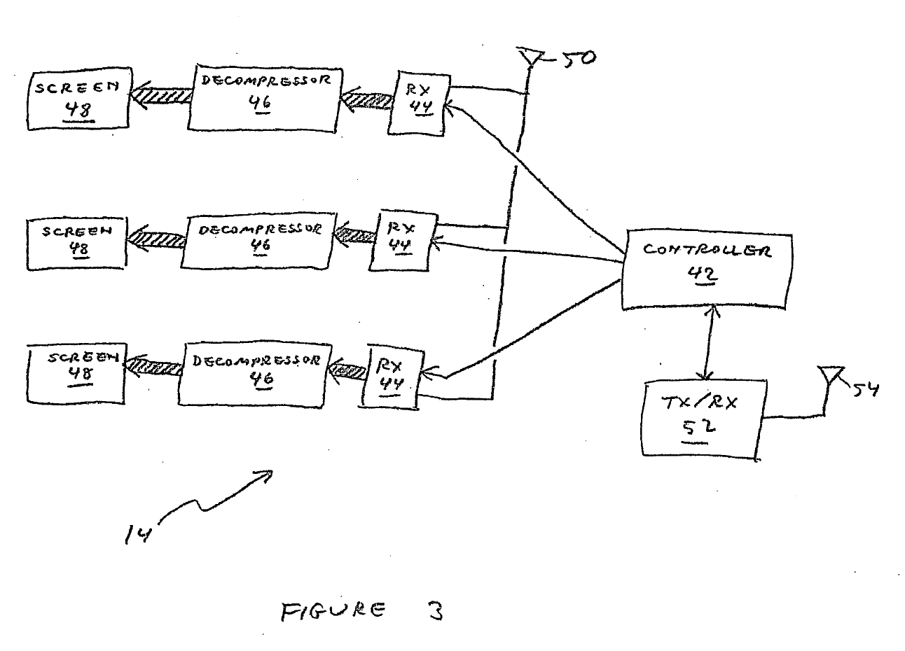

FIG. 3 is a high-level block diagram of control station 14. As in FIG. 2, the flow of video signals is indicated by thick arrows and the flow of control signals is indicated by thin arrows. Control station 14 includes several video receivers 44 and associated decompressors 46 and display screens 48, as well as a RF transceiver 52, all under the control of a controller 42. Video receivers 44 share a common antenna 50. Controller 42 instructs each video receiver 44 to receive video broadcasts in a respective subchannel of video channel 18. Each video receiver 44 sends the compressed video frames thus received to a corresponding decompressor 46 that decompresses the video frames and sends the decompressed video frames to a corresponding display screen 48 for display. Controller 42 also uses transceiver 52 to send instructions to video monitors 12 regarding which video monitors 12 are to broadcast in which subchannels of video channel 18 and to receive information from video monitors 12. Transceiver 52 transmits and receives the associated RF signals in RF channel 20 via an antenna 54.

Decompressors 46 preferably are implemented in firmware.

Controller 42 is based on a conventional computer that includes a processor, a nonvolatile read/write memory such as a hard disk or a flash disk, and suitable peripherals for input and output. Controller 42 decides which video monitors 12 are allowed to broadcast, and in which subchannels of video channel 18, according to rules that are stored in the nonvolatile memory of controller 42. An example of a set of such rules is given below. The operator of control station 14 can modify or replace the rules at any time, even during an ongoing operation. The operator of control station 14 also can override the rules manually at any time, for example to tilt or zoom the field of view of a video monitor 12.

Controller 42 also uses transceiver 52 to assign each user terminal 16 to a respective video monitor 12, by instructing each user terminal 16 which subchannel of video channel 18 to tune to.

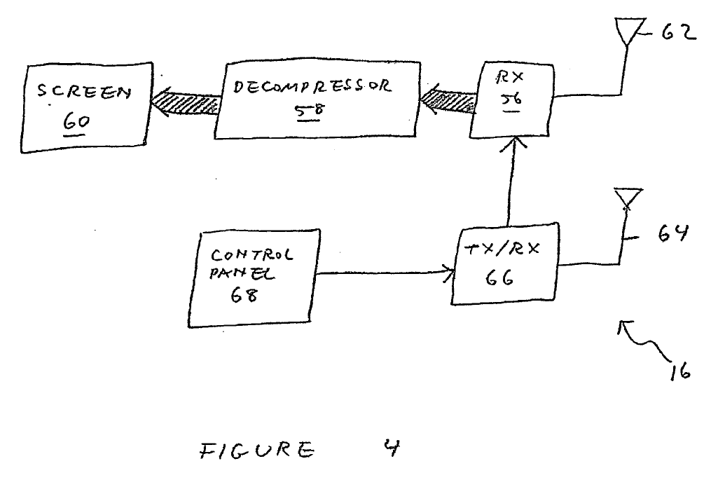

FIG. 4 is a high-level block diagram of a user terminal 16. As in FIGS. 2 and 3, the flow of video signals is indicated by thick arrows and the flow of control signals is indicated by thin arrows. User terminal 16 includes a video receiver 56, a decompressor 58, a display screen 60, a RF transceiver 66 and a control panel 68. Video receiver 56 receives broadcasts on video channel 18 via an antenna 62. Transceiver 66 transmits and receives in RF channel 20 via an antenna 64. In particular, transceiver 66 receives, from control station 14, instructions that assign user terminal 16 to a particular subchannel of video channel 18. In response to these instructions, transceiver 66 tunes video receiver 56 to that subchannel of video channel 18. Video receiver 56 then receives video broadcasts in that subchannel. The video frames thus received are decompressed by decompressor 58 and are displayed at display screen 60.

Preferably, decompressor 58 is implemented in firmware.

The user of user terminal 16 uses control panel 68 to send to control station 14 requests to change the subchannel of video channel 18 that is assigned to user terminal 16 and to change the field of view of the corresponding video monitor 12. In one exemplary configuration of system 10, the user of user terminal 16 is free to override manually the subchannel selections and fields of view that are determined by the rules of control station 14 but control station 14 is free to override the subchannel and field of view that is selected by the user of user terminal 16.

Note that in contrast to video channel 18, that lacks sufficient bandwidth for all video monitors 12 to broadcast their video frames simultaneously, RF channel 20 preferably is wide enough to accommodate simultaneously the wireless transmissions of all transceivers 32, 52 and 66.

System 10 is intended to be used by a team of military or law enforcement personnel. Typically, the team leader is the operator of control station 14 and every other team member is given a respective user terminal 16.

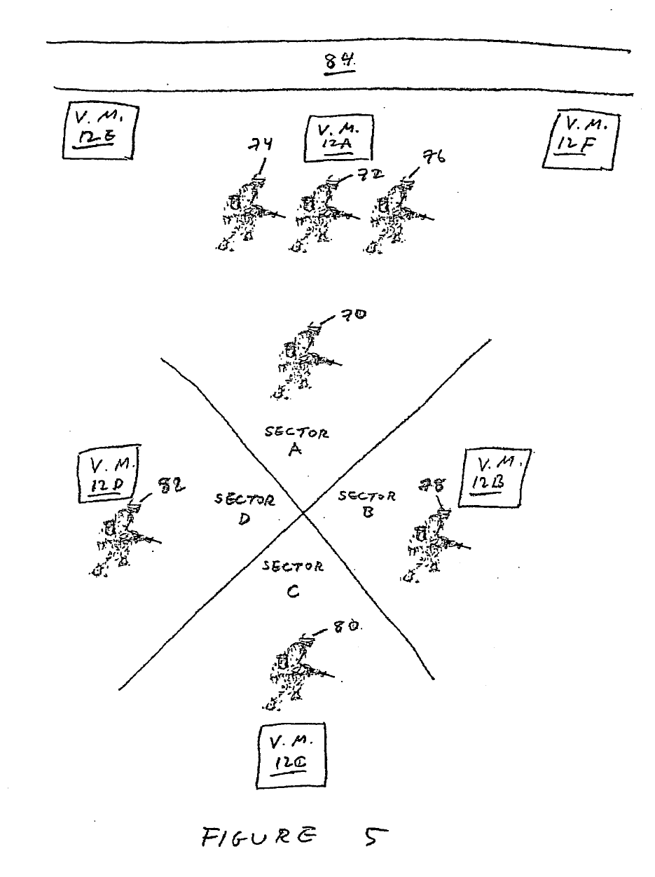

FIG. 5 illustrates an exemplary deployment of system 10. In this example, a squad of soldiers is assigned to intercept a suspicious vehicle that is expected to travel from right to left on a road 84. Four video monitors 12A through 12D are deployed around the squad's position to guard against hostile forces approaching four sectors A, B, C and D. Two video monitors 12E and 12F are deployed to monitor, respectively, traffic approaching on road 84 from the left and traffic approaching on road 84 from the right. Video monitor 12A also monitors traffic on road 84. The squad commander 70 is stationed in the middle of the squad's position along with a control station 14 (not shown). Three soldiers 72, 74 and 76 are stationed at road 84 to intercept the suspicious vehicle. Three soldiers 78, 80 and 82 are stationed in sectors B, C and D, respectively, to guard against a counterattack. Each soldier has his own user terminal 16 (not shown). In this example, video channel 18 is wide enough for only two video monitors 12 to broadcast simultaneously and control station 14 has only two sets of video receivers 44, decompressors 46 and video screens 48. In other words, video channel 18 includes only two video broadcast subchannels, which are designated subchannels 1 and 2.

The following are the rules that control station 14 uses to allocate subchannels 1 and 2 among video monitors 12.

Regime I: Default: Subchannel 1 cycles through video monitors 12A, 12B, 12C and 12D. Subchannel 2 cycles between video monitors 12E and 12F. Each video monitor 12 is given the same broadcast time. Soldier 72, the second-in-command, receives broadcasts from video monitors 12E and 12F on his user terminal 16. Soldiers 74 and 76 receive broadcasts from video monitor 12A on their user terminals 16. Soldier 78 receives broadcasts from video monitor 12B on his user terminal 16. Soldier 80 receives broadcasts from video monitor 12C on his user terminal 16. Soldier 82 receives broadcasts from video monitor 12D on his user terminal 16.

Regime II: Movement detected by video monitor 12A, 12B, 12C or 12D: Subchannel 1 is dedicated to the video monitor 12 that detected movement. Subchannel 2 cycles through the other three video monitors that are deployed around the squad's position. Each video monitor of subchannel 2 is given the same broadcast time (e.g., five seconds each per cycle). Soldier 72 receives broadcasts from the video monitor 12 that detected movement. Soldiers 74 and 76 receive broadcasts from video monitor 12A. Soldier 78 receives broadcasts from video monitor 12B. Soldier 80 receives broadcasts from video monitor 12C. Soldier 82 receives broadcasts from video monitor 12D.

Regime III: Leftbound traffic detected by video monitor 12F: Subchannel 1 is assigned to one of the video monitors 12 other than video monitor 12A, according to the motion detected by those video monitors 12, with priorities determined as follows:
12F (leftbound traffic)>12E (rightbound traffic)>12B (any motion)>12D (any motion)>12C (any motion)
   After the leftbound traffic that triggered regime III has departed the field of view of video monitor 12F, subchannel 1 is assigned to one of the other video monitors 12 according to these priorities. Then, for example, if subchannel 1 is assigned to video monitor 12B and video monitor 12E subsequently detects rightbound traffic, subchannel 1 is reassigned to video monitor 12E. Meanwhile, subchannel 2 is dedicated to video monitor 12A. Soldiers 72, 74, 76 and 78 receive broadcasts from video monitor 12A with high priority, for identification of the suspicious vehicle, and from video monitor 12A with medium priority, to monitor vehicles approaching the squad's position. Soldier 82 receives broadcasts from video monitor 12E with high priority and from video monitor 12A with medium priority, to monitor vehicles approaching from the left. Soldier 80 receives broadcasts from video monitors 12B, 12C and 12D with high priority and from video monitor 12A with medium priority.

Both regimes II and III have priority over regime I. Regime III has priority over regime II. In other words, receipt by control station 14 from any of video monitors 12A, 12B, 12C or 12D of notification of an unusual event causes control station 14 to switch from regime I to regime II, and receipt by control station 14 from video monitor 12F of notification of an unusual event causes control station 14 to switch from either regime I or regime II to regime III.

While the invention has been described with respect to a limited number of embodiments, it will be appreciated that many variations, modifications and other applications of the invention may be made.

What is claimed is:

1. A system for surveillance of a region of interest, comprising:
(a) a plurality of monitors, each monitor operative to acquire and to transmit periodically a description of a respective portion of the region of interest, said monitors being operative to transmit said descriptions in a first communication channel having insufficient bandwidth for all said monitors to transmit said descriptions simultaneously; and
(b) a control station for allocating respective portions of said channel to said monitors for said transmissions according to a plurality of rules;
wherein at least one of said rules includes feedback from said monitors that is separate from said descriptions.

2. The system of claim 1, wherein said transmissions of said descriptions are wireless transmissions.

3. The system of claim 1, wherein said feedback from said monitors is transmitted by said monitors to said control station in a second communication channel that is separate from said first communication channel.

4. The system of claim 3, wherein said second communication channel has sufficient bandwidth for all said monitors to transmit said feedback substantially simultaneously.

5. The system of claim 3, wherein said transmissions of said feedback are wireless transmissions.

6. The system of claim 1, wherein each said monitor is operative to identify a description, that said monitor acquires, as unusual, and wherein said feedback includes notification by said monitors of occurrences of said unusual descriptions.

7. The system of claim 6, wherein said monitors identify said unusual descriptions according to an absolute criterion

8. The system of claim 6, wherein said monitors identify said unusual description according to a relative criterion.

9. The system of claim 8, wherein each said monitor identifies each said unusual description relative to a plurality of descriptions previously acquired by said each monitor.

10. The system of claim 9, wherein said descriptions include video frames and wherein each said monitor identifies said unusual description as including unusual motion relative to a plurality of video frames acquired previously by said each monitor.

11. The system of claim 1, wherein said monitors transmit said descriptions by broadcasting said descriptions, the system further comprising:
(c) at least one terminal, separate from said control station, for receiving and displaying said broadcast descriptions.

12. The system of claim 11, wherein each said terminal is operative to receive said descriptions from only one said monitor at a time, and wherein said control station is operative to decide, for each said terminal, from which one of said monitors said each terminal receives said descriptions.

13. The system of claim 1, wherein said control station includes a plurality of display devices for displaying said descriptions currently being transmitted by said monitors.

14. The system of claim 13, wherein said display devices are equal in number to said monitors that transmit simultaneously in said first communication channel, and wherein said control station is operative to assign to each said display device a respective said monitor.

15. The system of claim 1, wherein each said monitor is operative to record said displays that said each monitor acquires while said each monitor is denied a portion of said first communication channel.

16. A method of surveillance of a region of interest, comprising the steps of:
(a) deploying, in the region of interest, a plurality of monitors, each monitor operative to acquire and transmit periodically a description of a respective portion of the region of interest;
(b) providing a communication channel having insufficient bandwidth for all said monitors to transmit said descriptions simultaneously; and
(c) allocating respective portions of said communication channel to said monitors for said transmissions according to a plurality of rules, at least one of said rules including feedback from said monitors that is separate from said descriptions.

17. The method of claim 16, further comprising the step of:
(d) modifying said rules while said monitor are transmitting said descriptions.

18. The method of claim 16, wherein said monitors transmit said descriptions by broadcasting said descriptions, the method further comprising the step of:
(d) for each of at least one said monitor that has been allocated a respective portion of said communication channel:
(i) assigning to said each monitor a respective terminal; and
(ii) displaying said descriptions, that are broadcast by said each monitor, using said respective terminal.
